(19) United States
(12) Patent Application Publication
(10) Pub. No.: US 2002/0060381 A1
(43) Pub. Date: May 23, 2002

(54) Method of producing a compensator for radiotherapy equipment and an apparatus for producing the same

(75) Inventor: Kiyoshi Yoda, Tokyo (JP)

Correspondence Address: LEYDIG VOIT & MAYER, LTD, 700 THIRTEENTH ST. NW, SUITE 300, WASHINGTON, DC, 20005-3960, US

(73) Assignee: Mitsubishi Denki Kabushiki Kaisha, Tokyo (JP)

(21) Appl. No.: 09/964,887

(22) Filed: Sep. 28, 2001

(30) Foreign Application Priority Data
Oct. 3, 2000 (JP) P 2000-303623

(51) Int. Cl. B29C 49/00

(52) U.S. Cl. 264/554; 425/388

(57) ABSTRACT

A method of producing a compensator for radiotherapy equipment which is capable to reuse and cheap in price, and an apparatus for producing the same. A mold consisting of a cluster of a plurality of rods which can be moved back and forth in the longitudinal direction thereof is inserted into a frame, and the mold surface which is constituted from the end faces of the rods is formed into a desired shape by controlling longitudinal forward and backward movement of each rod. A thermally formable sheet which has been heated and softened is placed on the mold surface, and the air between the mold surface and the sheet is evacuated, thereby to bring the sheet into close contact with the mold surface and harden the sheet in the desired shape.

### BACKGROUND OF THE INVENTION

1. Field of the Invention

The present invention relates to a method of producing a compensator for radiotherapy equipment using radiation such as proton beam or X-ray and, more particularly to a method of and an apparatus for producing a compensator for radiotherapy equipment that can be reused and is less expensive.

2. Description of the Related Art

FIG. 10 shows a prior art example of a radiotherapy equipment that uses proton beam, published by Kanai et al. on Medical Physics, 10 (3), May/June, 1983. Reference numeral 51 denotes a proton beam, 52 and 53 denote scattering screens that scatter the radiation so as to spread the beam, 54 denotes a beam intensity monitor, 55 denotes a computer, 56 denotes a water column that effects uniform attenuation of the proton beam energy, 57a and 57b denote multiple-leaf collimators that control the beam width, 60 denotes a compensator called bolus that causes attenuation of the radiation energy to a distribution corresponding to the size and shape of a tumor in a human body and is made of a material such as acrylic resin which attenuates the radiation energy by a similar amount that water does. Reference numeral 61 denotes a human body, 62 denotes a target of radiation such as the tumor in a human body, and 63 denotes an organ such as spinal cord that is located behind the tumor and is vulnerable to the radiation.

In FIG. 10, the bolus 60 is formed to have a surface of a shape similar to the deepest bottom surface shape of the target of radiation 62. Since radiation consisting of particles such as proton shows the phenomenon of dosage concentration in which a deeper portion receives a higher dose of radiation, the radiation beam must be aimed so that the position of the highest dose is located in the tumor. For this purpose, the bolus is formed to have a shape similar to the deepest bottom surface shape of the tumor, so that the tumor receives the highest dose of radiation while the spinal cord 63 located just behind the tumor is not irradiated, thus protecting the spinal cord 63.

In the case of electromagnetic radiation such as X-ray, on the other hand, the dose tends to be higher on the surface while decreasing with the penetration depth. Thus the tumor is irradiated with X-ray in various directions while varying the spatial distribution of the X-ray intensity by means of a compensator, so that only the tumor receives high dose of radiation while the intensity of radiation received by the normal tissue that surrounds the tumor is minimized so as to prevent side effects. Such a compensator is used that is made by machining a metal block into a thickness distribution predetermined by computation.

### SUMMARY OF THE INVENTION

However, since the use of proton beam makes it necessary to use a bolus having a shape formed to match the shape of the tumor, boluses must be made for each patient and for each direction of irradiation while changing the boluses during a therapeutic session, resulting in a high producing cost of the boluses and a long period of time required in the therapeutic operation. This gives rise to another problem that it is not possible to perform within a short period of time the multidirectional irradiation that is essential for avoiding to cause side effects in normal tissues. In the case of X-ray irradiation, in addition to problems similar to those of the proton beam, there has been-the problem of using the metal block that is difficult to machine and is not easy to handle because of its heavy weight.

The present invention has been made to solve the problems described above, and has an object to provide a method of and an apparatus for producing a compensator for radiotherapy equipment that is easier to manufacture while requiring lower cost, and replaces the conventional compensator that requires a long time to manufacture and is expensive.

In order to achieve the object described above, the method of producing the compensator for radiotherapy equipment of the present invention includes inserting a mold consisting of a cluster of a plurality of rods which can be moved back and forth in the longitudinal direction thereof into a frame; controlling longitudinal movement of each rod so as to form the mold surface, that is constituted from the end faces of the rods, into a desired shape; placing a thermally formable sheet which has been heated and softened on the mold surface; and evacuating the air between the mold surface and the sheet, thereby to bring the sheet into close contact with the mold surface and harden the sheet in the desired shape.

The frame has preferably a box shape having an opening through which the rods protrude, with a provision to seal the inner space airtight after being evacuated, so that the pressure between the mold surface and the sheet can be reduced by evacuating the inside of the frame.

Also the frame has preferably an exhaust section so that the pressure between the mold surface and the sheet can be reduced by evacuating the gaps between the rods or the inside of through-holes formed in the rods in the longitudinal direction, by an evacuation means connected to the exhaust section.

It is also preferable to apply a pressure to the external surface of the sheet while evacuating the air from between the mold surface and the sheet, in order to bring the sheet into closer contact with the mold surface.

The apparatus for producing the compensator for radiotherapy equipment of the present invention forms the compensator by bringing the thermally formable resin sheet into close contact with the mold surface, and includes a mold consisting of a cluster of a plurality of rods which can be moved back and forth in the longitudinal direction thereof; a frame of which inner space can be evacuated wherein the mold is held; a mold surface forming means that controls the longitudinal movement of each rod so that the end faces of the rods form the mold surface of a desired shape; and an evacuation mechanism that exhausts the air from the inside of the frame, thereby reducing the pressure between the resin sheet that has been heated and softened and the mold surface, so that the sheet is brought into close contact with the mold surface.

Such a constitution may also be employed as the evacuation mechanism includes an exhaust section formed in the frame and evacuation means connected to the exhaust section, wherein the pressure between the mold surface and the sheet can be reduced by evacuating the gaps between the rods or the inside of through-holes formed in the rods in the longitudinal direction through the exhaust section.

Such a constitution may also be employed as the mold surface forming means includes a longitudinal motion mechanism that move each rod individually in the longitudinal direction, a rod hooking mechanism that temporarily clamps the rods which have been moved, and a control mechanism that determines the distance of longitudinal movement for each rod according to mold surface shape data which has been input thereto and directs the longitudinal motion mechanism to move each rod in the longitudinal direction.

Such a constitution may also be employed as the rod hooking mechanism includes a plurality of link bars of which one end is connected to the other end of the rod so as to transmit the moving force from the longitudinal motion mechanism to the rods, and a hooking section that temporarily hooks the link bars and clamps the rods.

Such a constitution may also be employed as the longitudinal motion mechanism includes a longitudinal motion drive bar of which one end is connected to the other end of the link bars so as to move the link bars back and forth, and positioning means that supports the longitudinal motion drive bar movably back and forth in the longitudinal direction, moves the longitudinal motion drive bar in a direction perpendicular to the longitudinal direction of the rod so that one end of the longitudinal motion drive bar faces the other end of the link bars and moves the longitudinal motion drive bar back and forth in the longitudinal direction of the rod.

Such a constitution may also be employed as the frame includes a box having an opening made in the top surface for the rods to protrude therethrough, and a plurality of guide holes arranged in the bottom to oppose the other ends of the rods, while the link bars penetrate through the guide holes and are connected to the other ends of the rods.

### BRIEF DESCRIPTION OF THE DRAWINGS

FIG. 1 schematically shows a process for producing the compensator according to a preferred embodiment of the present invention.

FIG. 2 schematically shows the process of forming the mold 2 shown in FIG. 1B in a sectional view.

FIG. 3 shows the shape of the compensator according to a preferred embodiment of the present invention, in a perspective view with a convex portion facing up in FIG. 3A and in a perspective view with a concave portion facing up in FIG. 3B.

FIG. 4 is a perspective view schematically showing the compensator that has metal beads in the concave portion.

FIG. 5 is a schematic sectional view of the compensator according to a preferred embodiment of the present invention comprising a case containing metal beads and a formed sheet.

FIG. 6 is a schematic sectional view of the compensator according to a preferred embodiment of the present invention containing a liquid in a concave portion.

FIG. 7 is a sectional view schematically showing an X-ray radiotherapy equipment that uses an X-ray irradiation apparatus employing the compensator manufactured according to the present invention.

FIG. 8 schematically shows an X-ray radiotherapy equipment in operation that uses an X-ray irradiation apparatus employing the compensator manufactured according to the present invention.

FIG. 9 schematically shows the relation between the shape of the compensator and X-ray intensity distribution in an X-ray irradiation apparatus employing the compensator manufactured according to the present invention.

FIG. 10 is a schematic sectional view showing the shape of bolus and the shape of tumor in the case of a proton beam irradiation apparatus of the prior art.

### PREFERRED EMBODIMENTS OF THE INVENTION

This application is based on application No.2000-303623 filed Oct. 3, 2000 in Japan, the content of which is incorporated hereinto by reference.

Preferred embodiments of the present invention will now be described with reference to the accompanying drawings.

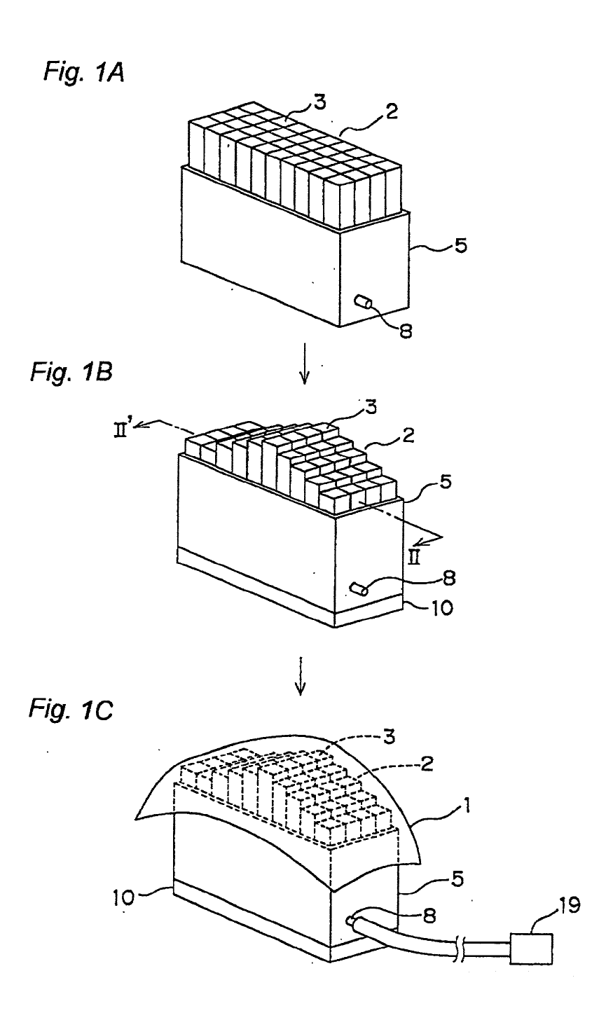

FIG. 1 schematically shows processes of producing the compensator according to a preferred embodiment of the present invention. Although this embodiment relates to a method of producing the compensator by using a vertical mold wherein rods are erected vertically, the compensator can be manufactured similarly also when a horizontal mold is used in which the rods are disposed in the horizontal direction, except that the rods are moved back and forth in a horizontal direction in the latter case.

According to the present invention, a mold 2 consisting of a cluster of a plurality of rods 3 while a frame 5 holds the rods with the longitudinal direction thereof being at right angles to the bottom surface of the box shape of the frame by inserting the cluster of the rods through an opening, as shown in FIG. 1A. For example, the frame 5 may have a box shape that has an opening in the top surface through which the rods protrude while the inside of the box can be pumped vacuum. In FIG. 1, the plurality of rods 3 are arranged along x axis and y axis, while the mold 2 is held by the frame in close contact with the circumference thereof. Each rod can be moved back and forth in the longitudinal direction and air can be ventilated through the gaps between the rods.

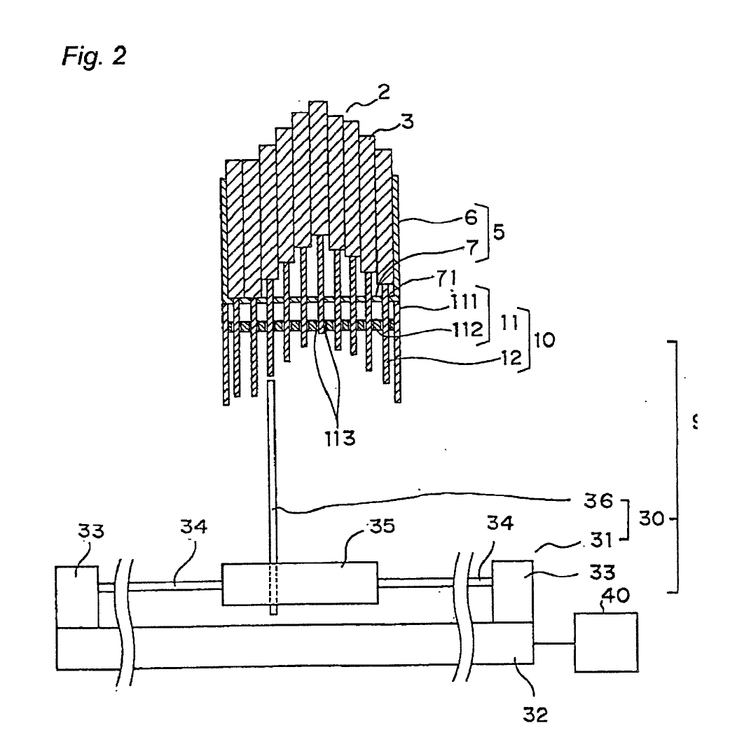

The mold surface forming means 9 shown in FIG. 2 controls the forward and backward movement of each rod in the longitudinal direction, so as to form the mold surface consisting of the end faces of the rods into a desired shape (FIG. 1B). Then the thermoplastic resin sheet 1 is placed on the mold surface after being softened by heating with heating means such as a hot plate. An evacuation mechanism 18 includes an exhaust section 8 and an evacuation means 19, and reduces the pressure between the mold surface and the sheet by evacuating the gaps between the rods or the inside of through-holes formed in the rods in the longitudinal direction. Exhaust holes are formed in the side wall of the frame 5 as the exhaust sections 8 and a vacuum pump is operated as the evacuation means 19, thereby to reduce the pressure between the mold surface and the sheet 1 (FIG. 1C). This causes the sheet 1 to cool down and harden while making close contact with the mold surface, thus forming the desired surface shape.

FIG. 2 schematically shows the structure of the mold 2 and the frame 5 in the sectional view taken along lines II-II' of FIG. 1B and the structure of the mold surface forming means 9. The mold surface forming means 9 has the rod hooking mechanism 10 that is disposed on the outer surface of the bottom of the frame 5 and temporarily clamps the rods 2 which have been moved, a vertical motion mechanism 30 that is disposed below the rod hooking mechanism 10 and moves the plurality of rods 2 as the longitudinal motion mechanism, and a control mechanism 40 that directs a vertical motion mechanism 30 to move the rods 2 vertically according to mold surface shape data which has been input thereto.

The rod hooking mechanism 10 includes a plurality of link bars 12 and a hooking section 11 that temporarily hooks with the link bars 12 so as to clamp the rods 3. The upper end faces of the link bars 12 make contact with the lower end faces of the rods 2 and penetrate through a plurality of guide holes 71 which are formed in the bottom of the frame 5 and are arranged to oppose the lower ends of the rods 2, so as to transmit the moving force of the vertical motion mechanism 30 to the rods 2 and move the rods 2 up or down.

On the other hand, the hooking section 11 includes a clamp plate 112 having a plurality of clamp members 113 that temporarily hold the plurality of link bars 12 and a support body 111 that supports the clamp plate 112, and is detachably installed on the outer surface of the bottom of the frame 5 so that the clamp members 113 oppose the lower end faces of all the rods 2.

The clamp plate 112 consists of, for example, a plate that has a plurality of through-holes wherein the link bars 12 penetrate, while the clamp member 113 may consists of a collet chuck installed on the through-hole. The plate may be disposed at a predetermined distance from the outer surface of the bottom of the frame 5 while being supported by the support body 111.

The vertical motion mechanism 30 includes a vertical motion drive bar 36 and positioning means 31. The vertical motion drive bar 36 moves the link bars 12 up or down by contacting the upper end faces thereof with the lower end faces of the link bars 12. The positioning means moves the vertical motion drive bar 36 to a predetermined position in the horizontal plane so that the upper end face of the vertical motion drive bar opposes the lower end face of the link bar 12 which has been selected, while causing vertical movement thereof.

The positioning means 31 includes a stage 32 having the shape of flat plate, a guide section 33 including a guide rail installed along the two parallel sides of the stage, a first carriage 34 capable of moving in the direction of X axis on the guide rail, and a second carriage 35 which is installed slidably along the first carriage and is capable of moving in the direction of Y axis. The first carriage 34 and the second carriage 35 are driven by a motor (not shown) that is connected to the control means 40.

The second carriage 35 further supports the vertical motion drive bar 36 vertically movably and has drive bar driving means (not shown) that drives the vertical motion drive bar 36. The drive bar driving means may be, for example, a motor that transmits the driving force via a rack and pinion to the vertical motion drive bar 36 thereby to move the vertical motion drive bar 36 up or down.

In the process of forming the mold surface, the control mechanism 40 sends a command to the vertical motion mechanism 30 according to the mold surface shape data which has been input thereto, thereby to cause the second carriage 35 to move to a predetermined position on the stage 31 and is positioned thereon so that the vertical motion drive bar 36 is located right below the specified link bar 12. Then the drive bar driving means is operated to move the vertical motion drive bar 36, that has been in standby, upward so that the rod 12 is moved upward by a predetermined distance via the link bar 12 which is in contact thereto, and the vertical motion drive bar 36 is stopped thereafter.

The clamp member 113 is released from the clamp mechanism when the link bar 12 is moving upward, and the clamp mechanism comes into operation to clamp the link bar 12 when the link bar 12 stops moving up. Thus the rods 12 can be moved upward by a predetermined distance and clamped without lowering.

In case the upward motion of the link bar 12 is once stopped and is then resumed, the clamp mechanism is reset to release the link bar 12. Moving down the link bar 12 under this condition allows the rods 12 to go down. Then with the link bar 12 being clamped by the clamp member 113 onto the hooking section 11, the vertical motion drive bar 12 is moved down to the standby position. This makes it possible to clamp one of the rods in the state of being moved up by a predetermined distance.

The control mechanism 40 causes the second carriage 35 to move to a predetermined position on the stage 31 and to be positioned at this position thereby to move the vertical motion drive bar 36 vertically for each rod, and repeats this operation sequentially for the plurality of rods which have been selected according to the mold surface shape data that has been input. This makes it possible to form the mold surface of the desired shape constituted from the upper end faces of the rods, on the top surface of the mold 2. After the mold surface has been formed, the thermoplastic resin sheet 1 that has been heated and softened is placed and brought into close contact with the mold surface as shown in FIG. 1 and is cooled and hardened in the desired shape.

In order to form the mold surface into another shape, clamping of the link bars 12 by the clamp member 113 is canceled and all the rods 2 are moved down to the bottom of the frame 5 and then the mold surface forming operation is carried out according to another set of mold surface shape data.

When the thermoplastic resin sheet 1 that has been heated and softened is brought into close contact with the mold surface and formed into a shape, the sheet 1 can be brought into close contact with the mold surface in a shorter period of time by applying a pressure on the outer surface of the sheet 1. For example, in FIG. 1C, after placing the softened sheet 1 on the mold surface, the opening of the frame 5 may be closed airtight by means of a lid that has a recess of such a size that does not make contact with the mold surface and a gas inlet port for pressurization, thereby introducing a pressurizing gas such as air or nitrogen.

Instead of placing the heated and softened sheet 1 on the mold surface, such a method may also be employed as the sheet 1 is placed on the mold surface to cover the entire surface of the mold, and then the sheet 1 is heated and softened by applying hot air by means of heating means such as drier. This method can reduce the time required for forming, since it is not necessary to move the sheet.

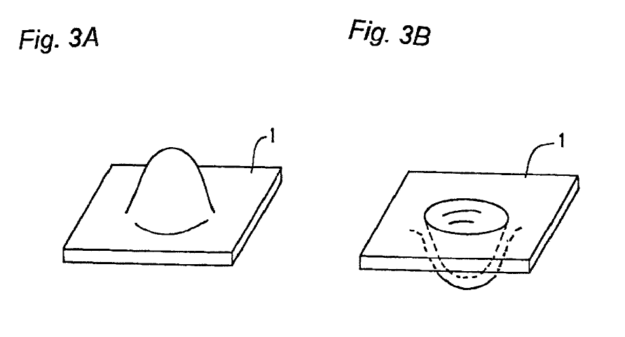

FIGS. 3A, 3B are perspective views of the thermoplastic resin sheet 1 that has been formed, with the convex facing upward and downward, respectively. In the case of proton beam, the thermoplastic resin sheet 1 is formed by adjusting the surface of the mold 8 to match the shape of the bottom surface of the tumor. In the case of X-ray beam, the thermoplastic resin sheet 1 is formed by adjusting the surface of the mold 8 according to the thickness distribution of the compensator that has been calculated beforehand.

Cross sectional shape of the rod may be either rectangular or circular, with the width or diameter thereof in a range from 2 to 20 mm, preferably from 5 to 10 mm. The rods may be made of either a metal or a resin as long as the material is resistant to the temperature at which the thermoplastic resin sheet is softened. When rods having rectangular cross section are used, through-holes may be bored to penetrate through the rods in the longitudinal direction thereof, thus accelerating the exhaust of air from the inside of the mold for closer contact of the sheet with the mold surface. Also the rod having rectangular cross section may be rounded or chambered on one corner over the entire length, thereby to form a gap between adjoining rods extending in the longitudinal direction which functions as a through-hole.

Rods made of a metal and rods made of a resin may also be arranged alternately to form the mold. This constitution makes the rod movement smoother and results in a shorter time required to form the mold surface, since the friction between the rods can be reduced during movement compared to the case of arranging the rods made of the same material.

While the link bars and the vertical motion drive bar may be made of the same material as the rods, a metallic material having higher strength is preferably used.

The thermoplastic resin sheet may be a homopolymer such as polyethylene, polypropylene, polyvinyl chloride, polystyrene, polyvinylidene chloride, fluororesin, polymethyl methacrylate, polyamide, polyester, polycarbonate, polyphenylene oxide, thermoplastic polyurethane and polyacetal, or a copolymer thereof.

The thickness of the thermoplastic resin sheet is in a range from 0.5 to 10 mm, preferably in a range from 1 to 5 mm. The sheet having the thickness in this range can be formed in a short time without taking much time for heating. The temperature to which the thermoplastic resin sheet is heated before forming is, for example, in a range from 70 to 100° C., preferably from 70 to 80° C. for polyethylene, polypropylene and polystyrene.

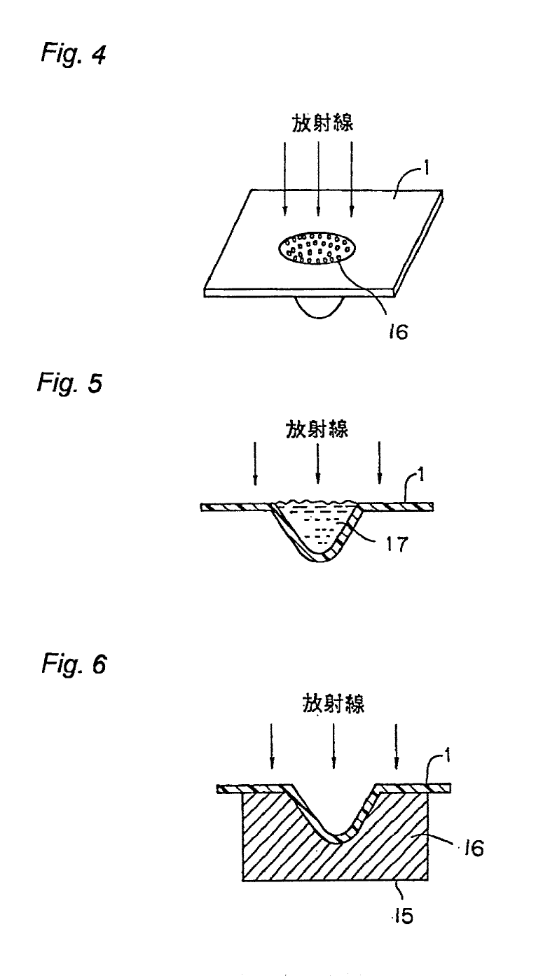

The formed compensator can be used in combination with a material opaque to radiation as shown in FIGS. 4 to 6. The compensator having the material opaque to radiation contained in the convex or concave portion can attenuate the energy of the radiation, either particles or X-ray in accordance to the shape thereof. FIG. 4 shows the compensator for X-ray, that has metal beads 16 as the material opaque to radiation in the concave portion of the thermoplastic resin sheet 1. Use of the metal beads makes the weight lighter than a metal block and makes it possible to easily vary the distribution of X-ray intensity by controlling the number and size of the beads.

The metal beads may be made of lead, tin or tungsten, or an alloy that includes at least one of these metals, while an alloy that includes tungsten is preferable because the compensator can be made thinner due to high radiation absorption coefficient of the material.

In the case of proton beam, beads made of a thermoplastic resin are preferably used as the material opaque to radiation instead of metal beads. Penetration of the proton beam can be easily controlled by controlling the number and size of the resin beads. Metal beads and resin beads have sizes in a range from 0.1 to 10 mm, preferably from 0.5 to 5 mm, which make it easier to handle and allow sufficient packing density for attenuating the energy of the radiation.

Also in the case of proton beam, as shown in FIG. 5, the concave portion of the thermoplastic resin sheet 1 may be filled with a liquid 17 instead of the resin beads. The liquid may be an inexpensive material that is stable when exposed to the radiation, such as water or silicone oil. Use of a liquid not only allows it to achieve similar effects as those of the metal beads or the resin beads, but also makes it possible to manufacture more inexpensive compensator.

The compensator for X-ray may also be made by placing the thermoplastic resin sheet 1 with the convex portion facing down on a case 15, and filling the case 15 with metal beads 16 as shown in FIG. 6. In the case of proton beam, resin beads may also be used instead of the metal beads 16. Similar effects as those attained with the metal beads or the resin beads can be achieved also with this constitution.

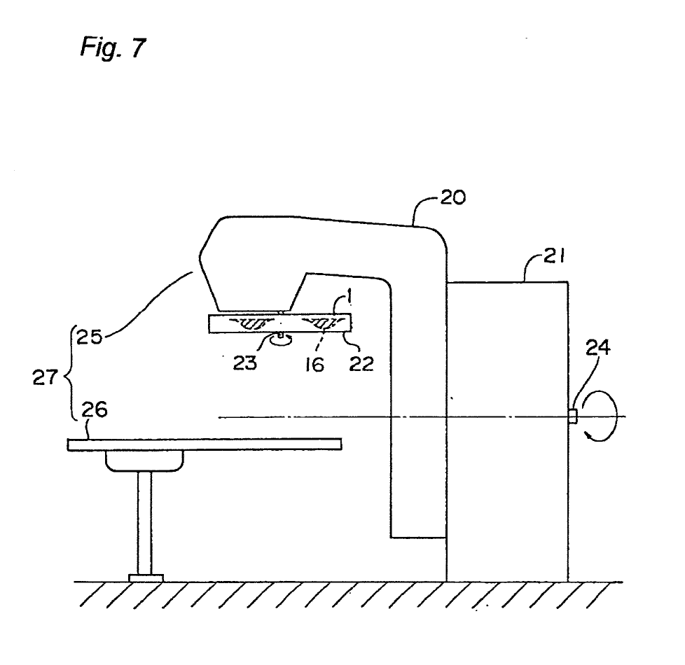

FIG. 7 is a sectional view schematically showing a radiotherapy equipment 27 comprising an X-ray irradiation apparatus 25 that uses the compensator made by the method of the present invention and a bed 26. The irradiation apparatus 25 is constituted from a main body 21 including radiation beam generating means, a rotary gantry 20, a compensator selector 22 and a rotary shaft 23 that holds the compensator selector 22 rotatably. The compensator selector 22 contains a plurality of compensators consisting of the formed thermoplastic resin sheet 1 that includes the metal beads 16 in the convex portion thereof, kept at a predetermined position.

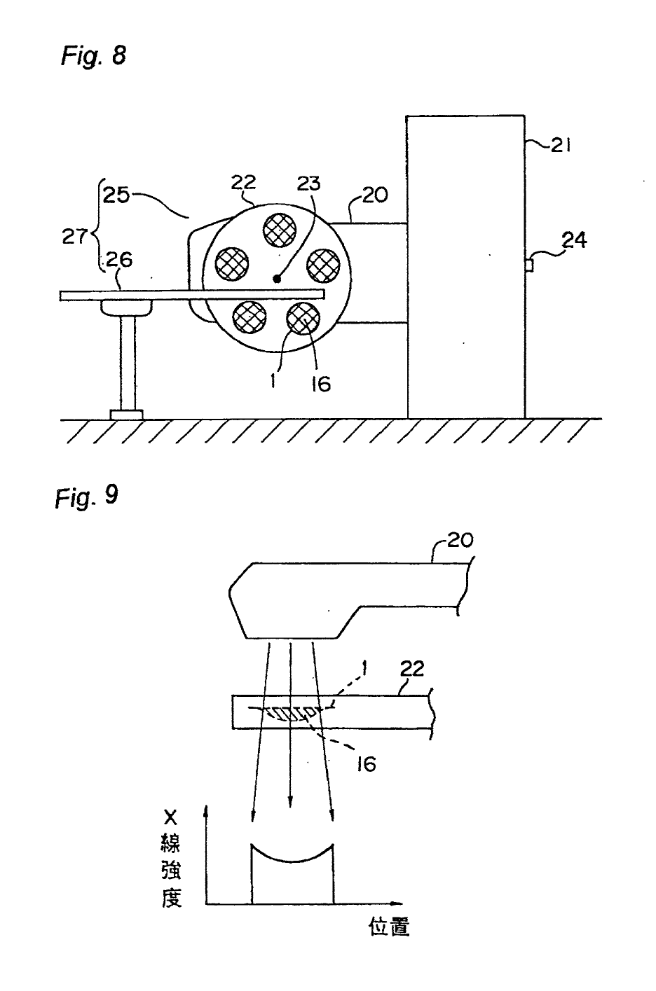

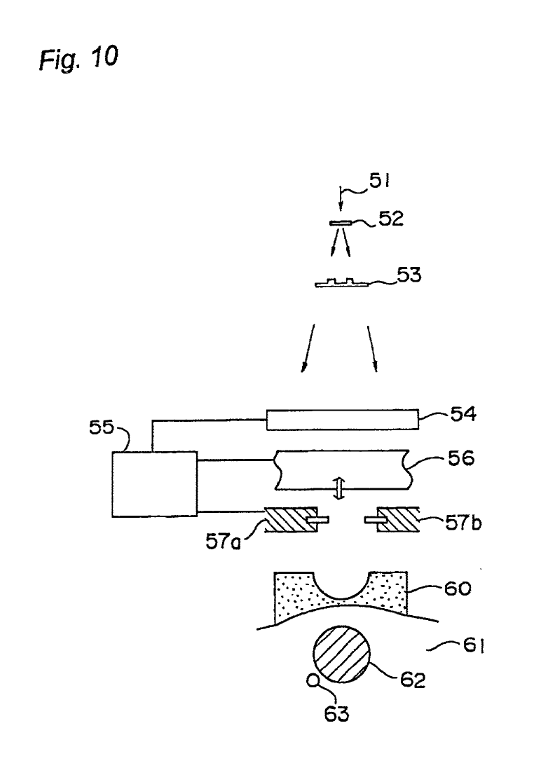

As shown in FIG. 8, the patient can be irradiated with X-ray in any direction by rotating the rotary gantry 20 around the rotary shaft 24. Irradiation is performed normally in about five different directions while the proper compensator for the irradiating direction is automatically selected by rotating the compensator selector 22.

X-ray emitted from the rotary gantry 20 is attenuated when passing through the compensator thereby changing the intensity distribution according to the position, as shown in FIG. 9. As a result, only the tumor can be exposed to a high dose of radiation while reducing the X-ray intensity to such a degree as the surrounding normal tissues are not subjected to side effects when irradiated in many directions. Distribution of X-ray intensity can be calculated according to a known mathematical algorithm.

Use of water or resin beads instead of the metal beads as the material opaque to radiation allows similar effects to be achieved, in an irradiation apparatus that uses heavy particle such as proton beam, besides the irradiation apparatus for x-ray.

As described above, the method of producing the compensator for radiotherapy equipment of the present invention includes inserting a mold consisting of a cluster of a plurality of rods which can be moved back and forth in the longitudinal direction thereof into a frame; controlling longitudinal forward and backward movement of each rod so as to form the mold surface, that is constituted from the end faces of the rods, into a desired shape; placing a thermally formable sheet which has been heated and softened on the mold surface; evacuating the air between the mold surface and the sheet, thereby to bring the sheet into close contact with the mold surface; and hardening the sheet in the desired shape. Therefore, the compensator that has high dimensional accuracy and can be used repeatedly can be easily manufactured thus reducing the time required for mounting on the compensator selector or changing the compensator, resulting in a shorter period of time required for the therapy, thereby making it possible to carry out irradiation in multiple directions in a shorter time. Also because the compensator can be reused, storage space for the compensators can be made smaller, while making the maintenance and management works easier than for the conventional irradiation apparatus.

The method of the present invention employs the box as the frame that has an opening through which the rods protrude with the inside of the box being evacuated and sealed to be airtight, while the pressure between the mold surface and the sheet is reduced by evacuating the inside of the frame, and therefore the sheet can be easily brought into close contact with the mold surface.

Also because a pressure is applied to the outer surface of the sheet while reducing the pressure between the mold surface and the sheet according to the method of the present invention, the sheet can be brought into close contact with the mold surface more quickly.

Also the apparatus for producing the compensator for radiotherapy equipment of the present invention comprises the mold consisting of the cluster of a plurality of rods that can be moved back and forth in the longitudinal direction thereof, the frame of which inner space can be evacuated wherein the mold is held; the mold surface forming means that controls the longitudinal forward and backward movement of each rod so that the end faces of the rods form the mold surface of a desired shape; and the evacuation mechanism that exhausts the air from the inside of the frame and reduce the pressure between the thermoplastic resin sheet that has been heated and softened the mold surface, thereby bringing the sheet into close contact with the mold surface. Therefore, the apparatus capable of easily producing compensators of various shapes can be provided.

Since the mold surface forming means of the apparatus of the present invention includes the longitudinal motion mechanism that moves the rods individually back and forth, the rod hooking mechanism that temporarily clamps the rods which have been moved, and the control mechanism that directs the longitudinal motion mechanism to move the rods according to mold surface shape data which has been input thereto, mold surfaces of various shapes can be automatically formed.

Since the rod hooking mechanism of the apparatus of the present invention includes the plurality of link bars that transmit the drive force from the longitudinal motion mechanism to the rods and the hooking section that temporarily holds the link bars and clamps the rods, clamping and releasing of the rods can be done easily.

Since the longitudinal motion mechanism of the apparatus of the present invention includes the longitudinal motion drive bar that moves the link bars back and forth, and the positioning means that supports the longitudinal motion drive bar to be movable back and forth in the longitudinal direction, moves the longitudinal motion drive bar in a direction perpendicular to the longitudinal direction of the rod so that one end of the longitudinal motion drive bar faces the other end of the link bar which has been selected and moves the longitudinal motion drive bar back and forth in the longitudinal direction of the rod, dimensional accuracy of the mold surface can be improved.

Since the apparatus of the present invention employs the frame that includes a box having an opening made in the top surface through which the rods can protrude and a plurality of guide holes arranged in the bottom to oppose the other ends of the rods, while the link bars penetrate through the guide holes and are connected to the other ends of the rods, the link bars can be connected accurately to the rods.

What is claimed is:

1. A method of producing a compensator for radiotherapy equipment, comprising the steps of:
inserting a mold consisting of a cluster of a plurality of rods which can be moved back and forth in the longitudinal direction thereof into a frame;
controlling longitudinal forward and backward movement of each rod so as to form the mold surface, that is constituted from the end faces of the rods, into a desired shape;
placing a thermally formable sheet which has been heated and softened on the mold surface; and
evacuating the air between the mold surface and the sheet, thereby to bring the sheet into close contact with the mold surface and harden the sheet in the desired shape.

2. The method according to claim 1, wherein said frame has a box shape having an opening through which the rods protrude, with a provision to seal the inner space airtight after being evacuated, so that the pressure between the mold surface and the sheet can be reduced by evacuating the inside of the frame.

3. The method according to claim 2, wherein said frame has an exhaust section so that the pressure between the mold surface and the sheet can be reduced by evacuating the gaps between the rods or the inside of through-holes formed in the rods in the longitudinal direction, by an evacuation means connected to the exhaust section.

4. The method according to claim 1, wherein said sheet is brought in closer contact with the mold surface by applying a pressure to the external surface of the sheet while evacuating the air from between the mold surface and the sheet.

5. An apparatus for a method of producing a compensator for radiotherapy equipment, said method comprising bringing a thermally formable resin sheet into close contact with a mold surface, said apparatus comprising:
a mold consisting of a cluster of a plurality of rods which can be moved back and forth in the longitudinal direction thereof;
a frame of which inner space can be evacuated wherein the mold is held;
a mold surface forming means that controls the longitudinal movement of each rod so that the end faces of the rods form the mold surface of a desired shape; and
an evacuation mechanism that exhausts the air from the inside of the frame, thereby reducing the pressure between the resin sheet that has been heated and softened and the mold surface, so that the sheet is brought into close contact with the mold surface.

6. The apparatus according to claim 5, wherein said evacuation mechanism comprises an exhaust section formed in the frame and an evacuation means connected to the exhaust section, wherein the pressure between the mold surface and the sheet can be reduced by evacuating the gaps between the rods or the inside of through-holes formed in the rods in the longitudinal direction through the exhaust section.

7. The apparatus according to claim 5, wherein said mold surface forming means comprises a longitudinal motion mechanism that move each rod individually in the longitudinal direction, a rod hooking mechanism that temporarily clamps the rods which have been moved, and a control mechanism that determines the distance of longitudinal movement for each rod according to mold surface shape data which has been input thereto and directs the longitudinal motion mechanism to move each rod in the longitudinal direction.

8. The apparatus according to claim 7, wherein said rod hooking mechanism comprises a plurality of link bars of which one end is connected to the other end of the rod so as to transmit the moving force from the longitudinal motion mechanism to the rods, and a hooking section that temporarily hooks the link bars and clamps the rods.

9. The apparatus according to claim 8, wherein said longitudinal motion mechanism comprises a longitudinal motion drive bar of which one end is connected to the other end of the link bars so as to move the link bars back and forth, and positioning means that supports the longitudinal motion drive bar movably back and forth in the longitudinal direction, moves the longitudinal motion drive bar in a direction perpendicular to the longitudinal direction of the rod so that one end of the longitudinal motion drive bar faces the other end of the link bars and moves the longitudinal motion drive bar back and forth in the longitudinal direction of the rod.

10. The apparatus according to claim 8, wherein said frame comprises a box having an opening made in the top surface for the rods to protrude therethrough, and a plurality of guide holes arranged in the bottom to oppose the other ends of the rods, while the link bars penetrate through the guide holes and are connected to the other ends of the rods.
